(19) United States
(12) Patent Application Publication
(10) Pub. No.: US 2022/0376539 A1
(43) Pub. Date: Nov. 24, 2022

(54) SYSTEM AND METHOD FOR ALTERNATE CURRENT CHARGING WITH RECTANGULAR (SQUARE) WAVE

(71) Applicant: Elazar COHEN, Binyamina (IL)

(72) Inventor: Elazar COHEN, Binyamina (IL)

(21) Appl. No.: 17/744,682

(22) Filed: May 15, 2022

Related U.S. Application Data
(60) Provisional application No. 63/190,261, filed on May 19, 2021.

(51) Int. Cl. H02J 7/00; H02J 7/04

(52) U.S. Cl. CPC H02J 7/007182; H02J 7/04; H02J 7/0048

(57) ABSTRACT

A system for AC charging of a battery includes at least a modulated alternating current signal generator, a current amplifier, and a voltage controller. The modulated alternating current signal generator generates a rectangular wave.

### CROSS-REFERENCE TO RELATED APPLICATIONS

This application claims priority from U.S. provisional patent application 63/190,261, filed May 19, 2021, which is incorporated herein by reference.fg

### FIELD OF THE INVENTION

The invention relates to battery and capacitors charging, specifically Li-ion batteries (Li-ion, Li-Polymer, Li-Metal, solid-state Li-ion batteries, and semi-solid lithium-ion batteries).

### BACKGROUND

The challenge of clean energy and green transportation is to develop an equal substitution for fossil fuels. Battery charging time is one of the main issues today that many research groups try to solve. The limitation delays the widespread use of electric cars, as one expects to charge a car as fast as filling up a petrol tank. One of the limiters for fast charging is the battery resistance, according to Ohm's law, when the current increased, the voltage increased respectfully. Overheating is also a side effect, as well as dendrite formation and electrode corrosion.

The common charging methods for Li-ion batteries (LIB) are constant current (CC), constant current constant voltage (CCCV), and pulse charging.

E.C. Darcy for NASA introduced burp charging for NiMH batteries. The method introduced a small negative pulse during the rest period and claimed to improve the charging and cyclability of NiMH batteries. This method did not show improvement for Li-ion batteries. (Darcy 1998) (Wang 2016)

The use of alternating current (AC) is well known in the battery research field, mainly for EIS (Electrochemical Impedance Spectroscopy). Using an AC signal for various frequencies, one can determine electrochemical parameters, including the resistance, charge transfer, and mass transfer. It is well known that at a higher frequency, the impedance is smaller. (Macdonald 1992)

Alternate voltage technique has been studied for quite some time for electrodeposition of metals and electrophoretic deposition (EPD) of nanoparticles, ceramics, and polymers. The literature covers several waveform shapes for the deposition process, including sinusoidal triangular and square waveforms. (Dukhin 2005) (Cohen 2018) (Bunshah and Schwartz 1994) (Amman 2012). U.S. Pat. No. 8,829,859 “Charger automatically tracking an optimal charging frequency for sinusoidal wave batteries”, which is incorporated herein by reference, describes a sinusoidal ripple current (SRC) charging method. This method is further described in (Chen 2013).

### SUMMARY OF THE INVENTION

There is provided, in accordance with a preferred embodiment of the present invention, a system for AC charging of a battery. The system includes at least a modulated alternating current signal generator, a current amplifier, and a voltage controller. The modulated alternating current signal generator is to generate a rectangular wave.

Further, in accordance with a preferred embodiment of the present invention, the current amplifier is to receive the rectangular wave and magnify the current of the rectangular wave to a required range before feeding the rectangular wave to the battery.

Still further, in accordance with a preferred embodiment of the present invention, the voltage controller is to control a DC voltage of the battery and to feedback the modulated alternating current signal generator.

Moreover, in accordance with a preferred embodiment of the present invention, the modulated alternating current signal generator is to generate a rectangular wave by applying a square wave and changing a cycle duty of the square wave.

Further, in accordance with a preferred embodiment of the present invention, the modulated alternating current signal generator is to generate a rectangular wave with additional DC offset.

There is also provided, in accordance with a preferred embodiment of the present invention, a method for AC charging of a battery. The method includes at least feeding a battery with a modulated alternating current signal in the form of a rectangular wave; magnifying the current of the rectangular wave to a required range; and controlling a DC voltage of the battery in a pre-specified range.

Further, in accordance with a preferred embodiment of the present invention, the rectangular wave is achieved by applying a square wave and changing a cycle duty of the square wave.

Still further, in accordance with a preferred embodiment of the present invention, the rectangular wave is modulated such that a desired ratio between a positive peak area and a negative area of an amplitude of the rectangular wave is achieved.

Moreover, in accordance with a preferred embodiment of the present invention, an amplitude of the rectangular wave is changed according to a cutoff voltage of the battery, a state-of-charge of the battery or both.

Further, in accordance with a preferred embodiment of the present invention, the method also includes providing a compensating DC offset.

Finally, in accordance with a preferred embodiment of the present invention, the method also includes providing DC charging at a constant voltage.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a circuit diagram illustration of a charging device of the present invention, charging a battery;

FIGS. 2A-2D show examples of AC rectangular (unbalanced square) wave signals;

FIGS. 3A-3B illustrate example EIS (Electrochemical Impedance Spectroscopy) measurements for LIB;

FIG. 4 shows a typical AC charging profile;

FIG. 5 shows comparisons of charging methods received in an experiment by their discharge curves; and

FIG. 6 depicts a method for AC charging of a battery according to an embodiment of the invention:

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SPECIFIC EMBODIMENTS

The invention relates to devices and methods for charging batteries, specifically Li-ion batteries (LIB) such as Li-ion, Li-Polymer, solid-state Li-ion batteries, and semi-solid lithium-ion batteries, by a rectangular (square) wave, at a frequency higher than 1 KHz, and preferably higher than the minimal impedance (resistance) frequency of the battery. The charging process is done by the alternating output current and controlled by a voltage controller to charge the battery to the battery's cutoff recommended voltage (DC). In some cases when even faster charging is required, charging to an over voltage value above the recommended value can be done.

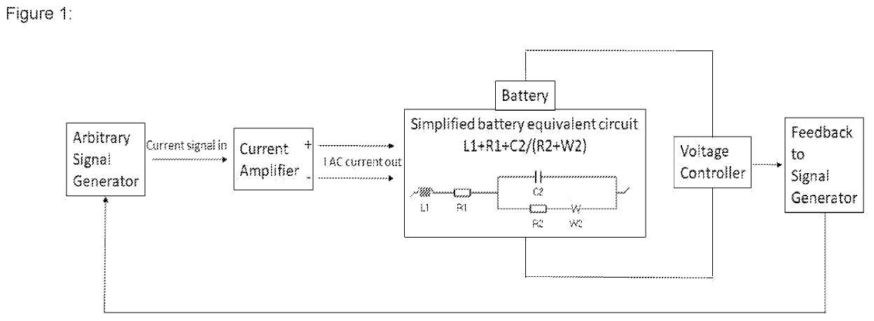

According to an aspect of the invention, the charging device comprises a modulated alternating current signal generator, a current amplifier, and a voltage controller. The alternating current signal generator, the current amplifier, and the voltage controller are arranged before and after the battery to be charged in the circuitry illustrated in FIG. 1. For ease of explanation, the battery circuit is illustrated as a simplified battery equivalent circuit.

The arbitrary signal generator enables the controllable rectangular (unbalanced square) wave, the frequency, and the amplitude of the wave.

The current amplifier provides a power amplifier in a current mode that magnifies the output current to the required current range.

The battery is the load (also can be represented as active load) in the circuit.

The voltage controller controls the battery DC voltage and sends the output to the signal generator to keep the voltage of the load (the battery) in the specific range according to the requirements of the battery (battery properties).

Charging is done using an alternate current waveform at a fixed frequency and specific initial amplitude to a cutoff voltage suitable for the battery chemistry and maintaining charging at a constant voltage by lowering the waveform amplitude respectively until reaching a cutoff state of charge (SOC). In some cases when extreeme fast charging is required, the amplitude may remain constant resulting with charging to an over voltage value above the recommended maximal charging voltage value of the battery.

By charging at alternating current at a mid-high frequency, the resistance of the battery is lower so it can be charged faster, at lower ambient temperature, and extend the cycle life of the battery. An occasional charge using this method can “refresh” the battery and reduce the inner resistance of the battery.

According to an aspect of the invention, the signal generator generates alternating current wave according to the following parameters:
Rectangular (unbalanced square) wave
Cycle duty of above 50% and less than 99%
Optional additional DC offset
Frequency of 1 KHz to 10 MHz

According to an aspect of the invention, the amplifier amplifies the current output to the required current output range depending on the battery capacity and the current required to charge the battery at a given c-rate.

According to an aspect of the invention, the voltage regulator controls the battery voltage and sends feedback to the signal generator.

The charging amplitude is changed according to the battery voltage (cutoff voltage) and the battery's state of charge (SOC). Additional DC current charging at constant voltage may be required to finalize the charging to 100% SOC.

The wave parameters (cycle duty, amplitude, DC offset, frequency) are controlled by the signal generator and explained in detail herein.

The rectangular wave is achieved by applying a square wave and changing the cycle duty between 1% to 99% cycle duty.

When looking at a single period with 95% cycle duty, during 95% of the period, the current is in one direction and 5% of the period the current is in the opposite direction, hence charging is occurring 95% of the period and discharging is occurring 5% of the period.

The amplitude, in this case, is symmetric and the same for the positive and negative peak of a period.

In addition, a DC offset may be applied to achieve the desired ratio of positive and negative peak area over a period. In this case, the amplitude is not the same for the positive and the negative peaks. For example, to achieve a 98% positive peak area over a period, a 90% cycle duty may be applied in addition to a compensating DC offset of 8%, so the overall positive and negative peak area ratio is maintained (98:2).

Several positive and negative amplitude ratios may be applied.

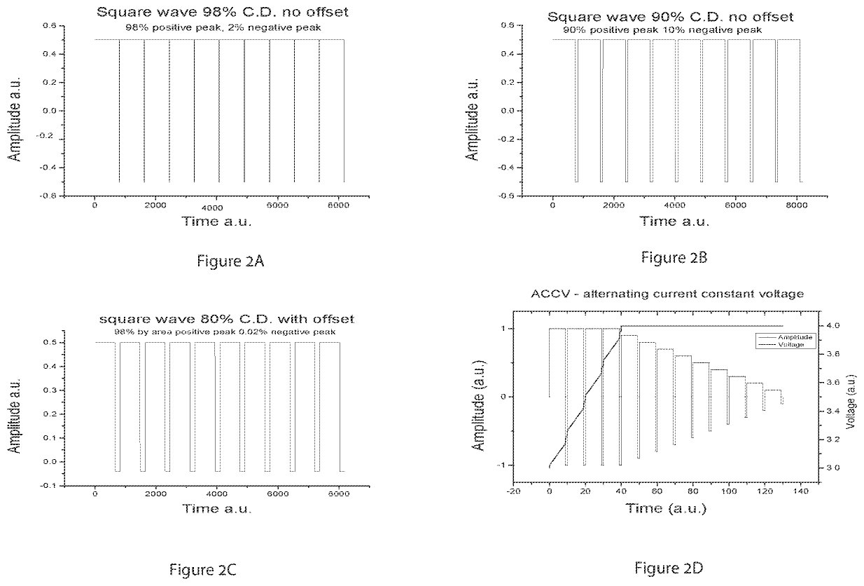

FIGS. 2A-2D show examples of AC rectangular (unbalanced square) wave signals.

Several positive and negative amplitude ratios are illustrated in FIGS. 2A-2C.

FIG. 2A shows a 98% cycle duty without offset. This wave applies 98% positive peak and 2% negative peak during one cycle. An offset suitable for LIB charging may also be used (not shown).

FIG. 2B shows a 90% cycle duty without offset. This wave applies a 90% positive peak and 10% negative peak during one cycle. An offset suitable for LIB charging may also be used (not shown).

FIG. 2C shows an 80% cycle duty with an offset suitable for LIB charging. This wave applies 98% positive peak by area and 2% negative peak by area during one cycle, achieved by the offset parameter.

FIG. 2D: An example for amplitude reduction to keep constant voltage is shown in FIG. 2D. As the battery is charged to a certain cutoff voltage, the amplitude is decreased to keep the charging at the constant cutoff voltage and finalize the charging process to maximum capacity.

This step can also be fulfilled with DC current at lower current ranges as a CCCV method.

The frequency for efficient charging may depend on the battery chemistry, the surface area of the battery, the electrolyte, the state of charge, and other parameters. To determine the desirable charging frequency, an EIS (Electrochemical Impedance Spectroscopy) test is suggested. Using an EIS test, the R bulk frequency and the minimal impedance frequency of the battery can be defined. The frequency should be higher than the R bulk frequency according to the Nyquist plot and preferred to be higher than the minimal impedance frequency according to the Bode plot. For example, for a given R-bulk frequency of 10 KHz and a minimal impedance frequency of 38 KHz the charging frequency can be 10 KHz. Better charging may be achieved at a charging frequency of 80 KHz, two times higher than the minimal impedance frequency. At frequencies below the minimum impedance of the battery, for example, at 1 KHz, sufficient charging also occurs, but at a longer charging time.

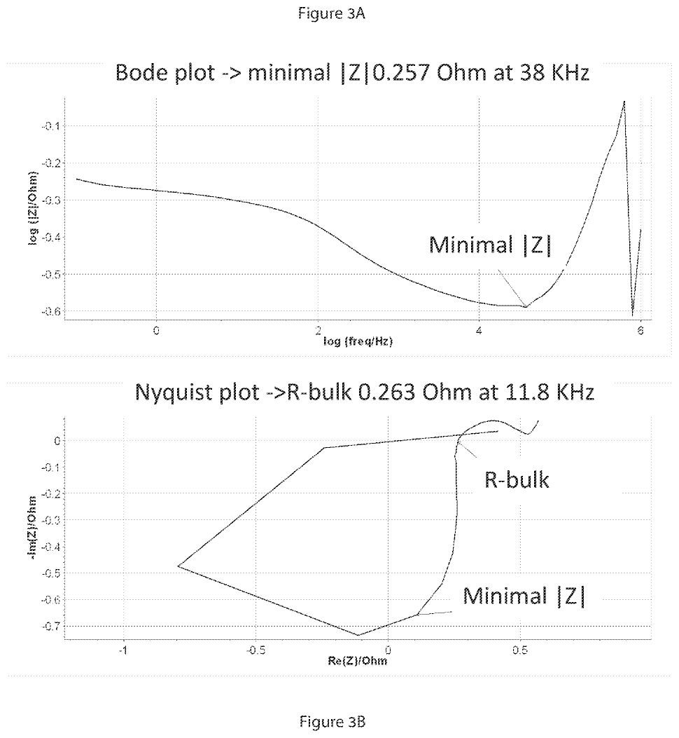

Batteries chemistry that was tested is LFP Vs. LTO, LFP Vs. Carbon, NCA Vs. Si and NCA Vs. Carbon, NMC Vs. Carbon. FIGS. 3A-3B illustrate example EIS (Electrochemical Impedance Spectroscopy) measurements for LIB.

FIG. 3A illustrates the Nyquist plot done to determine the R bulk frequency of the battery that was tested. In this non-limiting example, R bulk is 0.263 Ohm at 11.8 KHz (A).

FIG. 3B illustrates the Bode plot done to determine the minimal impedance frequency of the battery that was tested. In this non-limiting example, the minimal point is 0.257 Ohm at 38.0 KHz (B).

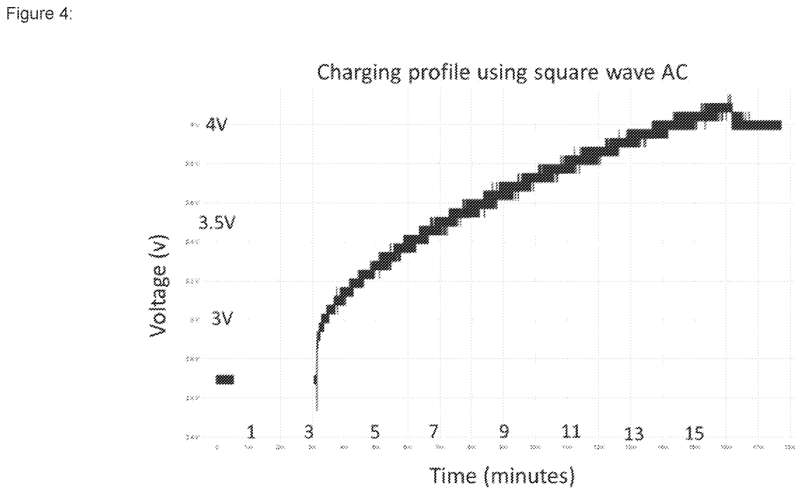

FIG. 4 shows a typical AC charging profile (voltage vs. time) by the ACCV (alternating current constant voltage) method using a rectangular (unbalanced wave) of 98% CD without offset.

In the graph, one can see that the voltage is rising in steps (up and a bit down) due to the alternating current applied.

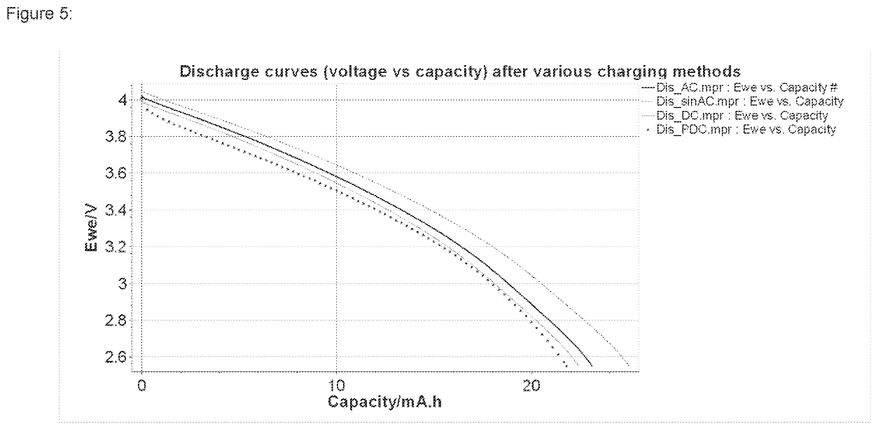

FIG. 5 shows comparisons of charging methods received in an experiment by their discharge curves. The plot shows the voltage against the percentage of capacity discharged. The charging results were received after discharging the battery at constant current after charging it by several methods.

The Discharge was performed at a constant current of 10 mA after charging by several charging methods.

The following charging methods were used: constant current (referenced in FIG. 5 as Dis_DC; Sinusoidal AC (referenced in FIG. 5 as DIS_SinAC); Pulse DC (referenced in FIG. 5 as Dis_PDC); and square wave AC (referenced in FIG. 5 as Dis_AC).

Experiment Parameters:

Cell: Tadiran TLI1020 (25 mAh) was used.

Charge current: 100 mA (4C).

Voltage window: 2.55 to 4.1, Discharge current: 10 mA (C/2.5).

The charging time and discharge capacity are summarized in Table 1.

TABLE 1
Charging time and discharge capacity data by charging method, of FIG. 5.

| Charging method | Charge time | Discharge capacity |
|---|---|---|
| Square wave AC | 12.2 min | 23.12 mAh |
| DC | 13.8 min | 22.44 mAh |
| Sinusoidal AC | 30.0 min | 25 mAh |
| Pulse DC | 34.0 min | 21.8 mAh |

Table 1 shows that a shorter charging time is achieved with the use of square wave AC charging: 12.2 minutes comparing the other charging methods.

Table 1 further shows that higher discharge capacity is achieved with the use of square wave AC charging comparing DC charging and pulse Dc charging.

The ability to achieve high discharge capacity in a short time is important for various applications. For example, while the highest discharge capacity, 25 mAh, was achieved with sinusoidal AC charging—it took 30 minutes, comparing the discharge capacity of 23.12 mAh achieved with square wave AC charging in 12.2 minutes.

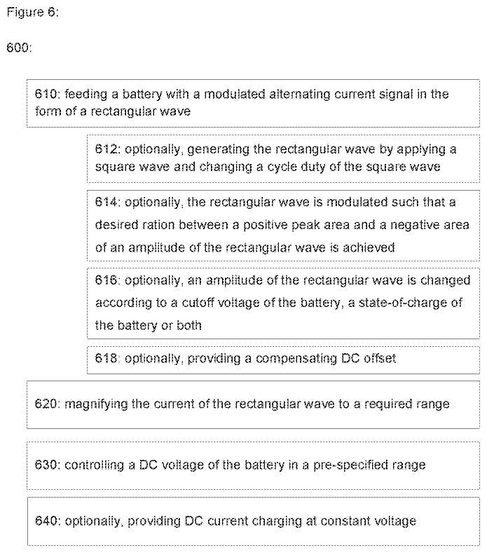

FIG. 6 depicts a method 600 for AC charging of a battery according to an embodiment of the invention:

Method 600 starts with operation 610 of feeding a battery with a modulated alternating current signal in the form of a rectangular wave. Optionally, the method comprises optional operations as follows:

Operation 612: optionally generating the rectangular wave by applying a square wave and changing a cycle duty of the square wave.

In operation 614, the rectangular wave is optionally modulated such that a desired ratio between a positive peak area and a negative area of an amplitude of the rectangular wave is achieved.

In operation 616, optionally, an amplitude of the rectangular wave is changed according to a cutoff voltage of the battery, a state-of-charge of the battery, or both.

Operation 618: optionally providing a compensating DC offset.

Either one of operations 610-618 is followed by operation 620, of magnifying the current of the rectangular wave to a required range.

Operation 630: controlling a DC voltage of the battery in a pre-specified range.

Optionality, in operation 640, providing DC current charging at constant voltage to thereby finalize the charging.

It will thus be appreciated that the embodiments described above are cited by way of example and that the present invention is not limited to what has been particularly shown and described hereinabove. Rather, the scope of the invention includes both combinations and sub-combinations of the various features described hereinabove, as well as variations and modifications thereof which would occur to persons skilled in the art upon reading the foregoing description and which are not disclosed in the prior art.

We claim:

1. A system for AC charging of a battery, comprising at least a modulated alternating current signal generator, a current amplifier, and a voltage controller, wherein the modulated alternating current signal generator is to generate a rectangular wave.

2. The system of claim 1 wherein the current amplifier is to receive the rectangular wave and magnify the current of the rectangular wave to a required range before feeding the rectangular wave to the battery.

3. The system of claim 1 wherein the voltage controller is to control a DC voltage of the battery and to feedback the modulated alternating current signal generator.

4. The system of claim 1 wherein the modulated alternating current signal generator is to generate a rectangular wave by applying a square wave and changing a cycle duty of the square wave.

5. The system of claim 1 wherein the modulated alternating current signal generator is to generate a rectangular wave with additional DC offset.

6. A method for AC charging of a battery, comprising at least feeding a battery with a modulated alternating current signal in the form of a rectangular wave;
magnifying the current of the rectangular wave to a required range; and
controlling a DC voltage of the battery in a pre-specified range.

7. The method of claim 6 wherein the rectangular wave is achieved by applying a square wave and changing a cycle duty of the square wave.

8. The method of claim 6 wherein the rectangular wave is modulated such that a desired ratio between a positive peak area and a negative area of an amplitude of the rectangular wave is achieved.

9. The method of claim 6 wherein an amplitude of the rectangular wave is changed according to a cutoff voltage of the battery, a state-of-charge of the battery or both.

10. The method of claim 6 further comprising providing a compensating DC offset.

11. The method of claim 6 comprising providing DC charging at a constant voltage.
